(19) United States
(12) Patent Application Publication
(10) Pub. No.: US 2021/0140210 A1
(43) Pub. Date: May 13, 2021

(54) Hinge with Set Screws

(71) Applicant: Shim-A-Hinge LLC, Boothwyn, PA (US)

(72) Inventors: Matteo Cannelongo, Middletown, DE (US); Kevin Lavin, Boothwyn, PA (US); Darrin Widger, Pennsville, NJ (US)

(73) Assignee: Shim-A-Hinge LLC, Boothwyn, PA (US)

(21) Appl. No.: 17/154,532

(22) Filed: Jan. 21, 2021

Related U.S. Application Data
(60) Provisional application No. 62/984,330, filed on Mar. 3, 2020.

(51) Int. Cl. E05D 7/00; E05D 3/02

(52) U.S. Cl. CPC E05D 7/0045; E05Y 2600/12; E05Y 2900/132; E05D 3/02

(57) ABSTRACT

A hinge with set screws is implemented which enables adjustments for a door without removing the hinge and installing a shim. The hinge's leafs are manufactured with one or more threaded holes that receive corresponding set, or adjustment, screws. The set screws enable adjustment of the hinge, when necessary. For example, the primary screws which connect the hinge to the door and frame may first be loosened to enable the user to utilize the set screws to adjust the door. The set screws can be loosened or tightened relative to the door or door frame—depending on which leaf is being adjusted—to adjust and provide the proper reveal between the door and the jamb. The set screws, therefore, enable door alignment without the use of a shim or cardboard. The use of the set screws can save valuable time in the construction industry in both commercial and residential settings.

### CROSS-REFERENCE TO RELATED APPLICATIONS

This Non-Provisional Utility patent application claims the benefit of and priority to U.S. Provisional Patent Application Ser. No. 62/984,330, entitled “Hinge with Set Screws,” filed Mar. 3, 2020, the entire contents of which is hereby incorporated herein by reference.

### BACKGROUND

A door may rub or impact against a head side, hinge side, or handle side of a door jamb when a new door is installed into a new frame. The misalignment of the door can be fixed by placing a shim, such as a piece of folded cardboard, between the door and jamb to maneuver the door to the appropriate position. This process can be time consuming and, in commercial settings like a hotel which has several hundred doors, the work hours can become excessive. Overtime, the cardboard or shim can break down which causes screws to become loose and the door to shift, thereby creating another project to readjust the door after the contractor is long gone from the job.

### SUMMARY

A hinge with set screws is implemented which enables adjustment for a door without removing the hinge and installing a shim. The hinge's leafs are manufactured with one or more threaded holes that receive corresponding set, or adjustment, screws. The set screws enable adjustment of the hinge when necessary. For example, the primary screws, which connect the hinge to the door and frame, may first be loosened to enable the user to adjust the set screws and door. In some implementations, the set screws can have flattened ends so that they do not cause damage to the frame's wood when installed. However, pointed ends are also possible to, for example, provide greater long-term strength when installed.

The set screws can be loosened or tightened relative to the door or door frame—depending on which leaf is targeted—to adjust and provide the proper reveal between the door and the jamb. The set screws, therefore, enable door alignment without the use of a shim or piece of cardboard. The set screws can be used by the user to, for example, adjust the door left or right within the frame. The present hinge with set crews can save valuable time in the construction industry in both commercial and residential settings. Homeowners can also use the disclosed hinge to make installing and/or adjusting doors easier.

### BRIEF DESCRIPTION OF THE DRAWINGS

FIG. 1 shows an illustrative representation of a closed door with a hinge;

FIG. 2 shows an illustrative representation of the door jamb for the opened door and a leaf of the hinge;

FIG. 3 shows an illustrative front side representation of the hinge with set screws;

FIG. 4 shows an illustrative rear side representation of the hinge with set screws;

FIG. 5 shows an illustrative representation of impact spots between a closed door and door frame;

FIG. 6 shows an illustrative representation of the hinge attached to the door frame;

FIG. 7 shows an illustrative representation of the loosened primary screws in the hinge; and

FIG. 8 shows an illustrative representation of the opposite side of the door shown in FIG. 7 while adjusting the set screws from the front.

Like reference numerals indicate like elements in the drawings. Elements are not drawn to scale unless otherwise indicated.

### DETAILED DESCRIPTION

FIGS. 1 and 2 show illustrative representations in which a hinge 105 is installed on a door 115 and the associated door frame 110. The hinge is the component that attaches the door to the door frame while also providing the ability for the door to open and close about the hinge. The hinge component may collectively be denoted by numeral 105 and individual components of the hinge may be given their own reference numbers, as further described below.

In typical implementations, the hinge 105 may be installed on the inside door jamb 210, as shown in FIG. 2, and the barrel or pin portion 125, shown in FIG. 1, is the pivot point about which the door 115 rotates, as representatively shown by numeral 120. FIG. 2 shows the inside portion of the hinge, namely, a leaf 205, which, in this implementation, attaches to the door frame using, for example, screws. Another leaf also attaches to the door which thereby attaches the door to the door frame via the hinge (not shown).

FIG. 3 shows an illustrative representation of a front side 330 of the hinge 105. The hinge is comprised of a door frame leaf 205 and a door leaf 305 which each have their own respective knuckles 320. The terms door frame leaf 205 and door leaf 305 are used for disambiguation purposes in the discussion herein, but the hinge may be symmetrical such that either leaf can be attached to a particular surface. The knuckles include a longitudinal hole in their center to enable receipt of a pin 325. In this implementation of a hinge, the pin extends fully from a top of the hinge to the bottom of the hinge so that the door leaf and door frame leaf are covered, and each knuckle receives the pin. In some implementations, the hinge may include a barrel portion that includes the knuckles and elements in between elements that receive the pin. One or more of these collective components may be the considered the barrel.

The door frame leaf 205 and door leaf 305 each have primary screw holes 310 which serve as openings to receive screws that secure the hinge 105 to a given surface, such as a door and door frame. The hinge also includes set, or adjustable, screws 315 that are dispersed throughout each leaf. Although not shown, the set screws 315 are inserted through holes, typically threaded holes, that are distinct from the primary holes. The primary holes are typically not threaded since the primary screws are secured to a frame or door, whereas the set screws are typically threaded since the set screws are primarily secured to the hinge.

In the present implementation, the set screw holes and set screws 315 are arranged at different quadrants of the leaf 205. The four quadrants may, for example, enable the left and right adjustability of the door 115. The four set screws shown is exemplary only, and additional or less set screws are also possible. Different locations of the set screws are also possible, such one or more set screws located in a center region of the leaf and which extend vertically, horizontally, diagonally, or any combination thereof. The length of the set screws may typically be a same size as a width of the hinge's leaf 205 (e.g., approximately a centimeter). In other implementations, the set screw used may be smaller than the leaf's width to, for example, completely pull the set screw inside the leaf if necessary while still being able to incrementally push out the set screw to the door or frame by tightening. Set screws longer than the width of the leaf may also be used in some implementations.

In typical implementations, the set screws 315 come pre-installed or pre-configured with the hinge 105 during the manufacturing process so that a consumer can utilize the hinge with set screws during their first and initial use without having to, for example, purchase and install the set screws. However, in other implementations, the hinge can be manufactured with the set screw holes and a downstream user or consumer can install the set screws themselves, as needed. The specific configuration may depend on, for example, costs associated with pre-configuring the hinge with set screws, the ability to allow an end user to select the set screws they want, among other factors. In other implementations, the set screw holes and set screws can be the same size to enable a user to select where they wish to install the primary screws and which holes to use for the set screws. In some embodiments, each of the holes may be threaded to enable the dynamic use of the holes.

FIG. 4 shows an illustrative representation of a rear side 405 of the hinge 105 in which the bottom of the set screws 315 are shown. Typically, the bottom of the set screws have flat heads 410 to be able to meet flat up against a surface, such as the surface of a door frame or door to which the hinge is attached. As discussed in further detail below, the set screws are adjusted inward and outward by clockwise and counter-clockwise movement, respectively. The inward and outward adjustability of the set screws enable the user to adjust the door's positioning inside the door frame. Slight adjustments of the hinge, which connects the door to the door frame, relative to the door and door frame can properly align the door within the door frame.

FIG. 5 shows an illustrative representation in which a door 115 can have impact spots against the door frame 110, as representatively shown by numeral 505. Since the hinge 105 is the component that connects and attaches the door to the door frame, the hinge can also be the component that causes misalignment of the door and thereby clashing between the door and door frame. Left alone, the impact spots caused by misalignment can cause damage to the door and door frame and frustration to users.

Typically, users, such as contractors or a handyman, use shims that are placed between the door and door frame to adjust the doors positioning and alignment relative to the door frame. However, the use of shims can be costly and time-consuming when, for example, hundreds of new doors are installed in a new building. Also, some doors can misalign over time for a home or building owner long after the contractor has departed. Use of the hinge with set screws enables a homeowner or contractor to adjust the door within the door frame with an additional tool that loosens or tightens the set screws.

FIG. 6 shows an illustrative representation in which the hinge 105 is attached to the door 115 and the door jamb 210 of the frame 110. The hinge is attached to the door jamb and door via primary screws 605 which are inserted into the primary screw holes 310 (FIGS. 3 and 4). Door frame leaf 205 and door leaf 305 are respectively connected to the door jamb and door, in which the knuckles 320 around the pin 325 enables the rotational opening and closing of the door relative to the frame (FIGS. 1 and 2).

FIG. 7 shows an illustrative representation in which a user loosens, using the drill 705, the primary screws 605 of the hinge 105 from the door jamb 210. The primary screws may be loosened to provide a space between the hinge and door frame or door so that the hinge can be adjusted and the door can be realigned. Loosening of the hinge from the door jamb (or door) provides a space for the user to adjust the set screws, such as tighten or loosen the set screws. Tightening or loosening the set screws enables the user to adjust the hinge's positioning of the door and overall alignment between the door and frame, and thereby preventing impact spots (505).

FIG. 8 shows an illustrative representation of the door 115 and the door frame 110 from a side opposite that shown in FIGS. 6 and 7. An adjustable space 805 is created between the door and frame by loosening the primary screws 605 (FIG. 7). Using this adjustable space, a user can loosen or tighten the set screws 320 to adjust the positioning and orientation of the hinge relative to the door frame. The user can adjust and test the alignment—or lack of impact spots—of the door relative to the frame. The set screws can be used to adjust the door's orientation to the left or right which thereby properly aligns the door within the frame and negate the impact spots. Set screws may be adjusted similarly or differently depending on the specific scenario. As shown in FIG. 8, the door's adjustment can be performed on the leaf associated with the door frame or the door. Once the door is properly aligned, the user can tighten the primary screws so that the hinge is fully secured to the door frame 110 or door 115.

Various exemplary embodiments for the hinge are disclosed herein. One exemplary embodiment includes a hinge with set screws, comprising: a frame leaf; a knuckle connected to and extending laterally from the leaf; a pin around which the knuckle is arranged; a frame hole on the leaf adapted to receive a primary screw; and a set hole on the leaf and through which a set screw is fastened, wherein the set screw is distinct form the primary screw.

In another example, the set screw is received and fastened to the set hole. In that example, the primary screw is received into the frame hole to fasten the hinge to a door frame, in which the set screw is distinct from the primary screw. In a further example, the set hole is a smaller size than the frame hole. As another example, the set hole is threaded to enable adjustment of the set screw and thereby the hinge when the hinge is attached to a door frame. Another example further comprises multiple set holes arranged on the leaf to enable adjustability of the hinge at multiple locations on the leaf. In that example, the set holes are arranged within quadrants of the leaf. Another example further comprises a door jamb leaf positioned on a side of the pin opposite the frame leaf, wherein the door jamb leaf likewise includes a set hole and a set screw.

In another example embodiment, disclosed is an adjustable hinge, comprising: a leaf; a knuckle connected to and extending laterally from the leaf; a primary screw hole on the leaf adapted to receive a primary screw; and a threaded set screw hole on the leaf that is distinct from the primary screw hole, wherein the primary screw hole is larger than the set screw hole.

As another example, multiple threaded set screw holes are arranged in quadrants on the leaf to enable left and right adjustability of the hinge. Another example further comprises set screws inside each of the threaded set screw holes. In another example, the set screws are a same length as a width of the leaf. In another example, a length of the set screws is smaller than a width of the leaf. As another example, an end of the set screws is flat to prevent damage to a door or frame to which the adjustable hinge is attached.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A hinge with set screws, comprising:
a frame leaf;
a knuckle connected to and extending laterally from the leaf;
a pin around which the knuckle is arranged;
a frame hole on the leaf adapted to receive a primary screw; and
a set hole on the leaf and through which a set screw is fastened, wherein the set screw is distinct form the primary screw.

2. The hinge of claim 1, wherein the set screw is received and fastened to the set hole.

3. The hinge of claim 2, wherein the primary screw is received into the frame hole to fasten the hinge to a door frame, in which the set screw is distinct from the primary screw.

4. The hinge of claim 2, wherein the set hole is a smaller size than the frame hole.

5. The hinge of claim 2, wherein the set hole is threaded to enable adjustment of the set screw and thereby the hinge when the hinge is attached to a door frame.

6. The hinge of claim 5, further comprising multiple set holes arranged on the leaf to enable adjustability of the hinge at multiple locations on the leaf.

7. The hinge of claim 6, wherein the set holes are arranged within quadrants of the leaf.

8. The hinge of claim 5, further comprising a door jamb leaf positioned on a side of the pin opposite the frame leaf, wherein the door jamb leaf likewise includes a set hole and a set screw.

9. An adjustable hinge, comprising:
a leaf;
a knuckle connected to and extending laterally from the leaf;
a primary screw hole on the leaf adapted to receive a primary screw; and
a threaded set screw hole on the leaf that is distinct from the primary screw hole, wherein the primary screw hole is larger than the set screw hole.

10. The adjustable hinge of claim 9, wherein multiple threaded set screw holes are arranged in quadrants on the leaf to enable left and right adjustability of the hinge.

11. The adjustable hinge of claim 10, further comprising set screws inside each of the threaded set screw holes.

12. The adjustable hinge of claim 11, wherein the set screws are a same length as a width of the leaf.

13. The adjustable hinge of claim 11, wherein a length of the set screws is smaller than a width of the leaf.

14. The adjustable hinge of claim 11, wherein an end of the set screws is flat to prevent damage to a door or frame to which the adjustable hinge is attached.
